(19) United States
(12) Patent Application Publication
(10) Pub. No.: US 2007/0162980 A1
(43) Pub. Date: Jul. 12, 2007

(54) SYSTEM AND METHOD FOR PROVIDING CONTENT SECURITY IN UPnP SYSTEMS

(75) Inventors: Seamus Moloney, Riihimaki (FI); Vlad Stirbu, Tampere (FI); Jose Costa-Requena, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/621,938

(22) Filed: Jan. 10, 2007

Related U.S. Application Data
(60) Provisional application No. 60/757,816, filed on Jan. 10, 2006.

(51) Int. Cl. H04L 9/32

(52) U.S. Cl. 726/27

(57) ABSTRACT

A Content Directory Service (CDS) security service specifying, in a user friendly manner, which users of a media server or other UPnP device own which content. The security service also permits the owners of content to control who is permitted to read the content. A CDS account manager is used to define user accounts and associated rights, such as validity periods and default rights. The CDS account manager is used by a security console which owns the media server. A CDS content manager is used to manipulate the rights to objects. The CDS content manager is used by a registered security aware control point (i.e., a control point associated with a user account) and can be used to change read and write access lists on the object.

### FIELD OF THE INVENTION

The present invention relates to content access management in universal plug and play (UPnP) devices. More particular, the present invention relates to systems for providing improved content security on UPnP media servers and other devices through access management.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP technology defines an architecture for pervasive peer-to-peer network connectivity of intelligent appliances, wireless devices, and personal computers of all form factors. UPnP is designed to bring easy-to-use, flexible, standards-based connectivity to ad-hoc or unmanaged networks, whether in the home, in a small business, public spaces, or attached to the Internet. UPnP technology provides a distributed, open networking architecture that leverages TCP/IP and Web technologies to enable seamless proximity networking, in addition to enabling control and data transfer among networked devices.

The UPnP Device Architecture (UDA) is designed to support zero-configuration, “invisible” networking and automatic discovery for a breadth of device categories from a wide range of vendors. With UDA, a device can dynamically join a network, obtain an IP address, convey its capabilities, and learn about the presence and capabilities of other devices.

The Content Directory Service (CDS) is the UPnP entity that aggregates the information about the media content available in the UPnP Network. The primary functions of the CDS are to enable clients to browse the content on the server and to obtain detailed information about individual content objects.

Currently, there is no user-friendly method for managing access to individual content items stored in a media server device such as a mobile telephone or a standalone home media server. One of the current weaknesses in the CDS is the inability to distinguish between the originators/creators of objects stored in the CDS others who not the originators or creators.

UPNP CDS versions 1.0 and 2.0 provide a method for restricting access to individual items stored in a device. This is accomplished by placing an attribute called “restricted” and “writeStatus” on individual items. However, this system does not include any metadata for providing access granularity on a per-user basis.

### SUMMARY OF THE INVENTION

The present invention provides a CDS security service which, in a user friendly manner, specifies which users of a media server or other UPnP device own which content, as well as permitting the owners to control who is permitted to read the content. A CDS account manager is used for defining user accounts and associated rights, such as validity periods and default rights. The CDS account manager is used by the security console or authorized control points which own the media server. A CDS content manager is used for manipulating the rights to objects. The CDS content manager is used by a registered security aware control point (i.e., a control point associated with a user account) and can be used to change read and write access lists on the object.

More broadly, the present invention provides for security middleware that is used on top of UPnP security in order to define user accounts, with the purpose of binding user ID's with device ID's. This middleware can also provide other functionality, such as providing device resource allocation per user account on each device. For example, the middleware can be used to allocate disk space, memory, quality of service (QoS) levels, and priority to specific actions when a device is congested. Other types of allocations are also possible.

The present invention comprises a method, computer program product, and a device for granting a control point certain access to an electronic device containing content objects. This system comprises receiving an identification of the control point; querying an owner of the electronic device as to the amount of access that should be granted to the control point; and, depending upon a response by the owner to the query, granting the control point selective access to the electronic device. Depending upon the owner's response to the query, no access rights can be granted for the control point to the electronic device, access rights can be granted to the control point as a guest to the electronic device, and access rights can be granted to the control point as a normal user to the electronic device. It is also possible for non-security aware legacy control points to be granted certain limited rights to the electronic device.

With the present invention, the CDS can work with users rather than individual control points. A number of control points can be grouped together as representing an individual user, and each of the control points will all get the same permissions, i.e., the permissions of the user. Therefore, the user interface for end users is simplified and, at the same time, security is improved. With the present invention, it is easy for a user to select one of his or her own pictures or other content items on the media server and, if so desired, allow that content item to be shared with another user of the media service, while permitting the other user only to read the content item. The present invention also provides enough flexibility so that legacy UPnP control points are capable of utilizing the same accounts. The present invention can be used in a wide variety of products that are media oriented, and particularly products that are designed to manage content.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of a security console embedded in a media server;

FIG. 2 is a depiction of an external security console located in a device such as a mobile telephone;

FIG. 3 is a diagram showing a sequence of actions which take place when a new control point is granted access to a media server according to one embodiment of the present invention;

FIG. 4 is a diagram showing how a non-security aware legacy control point can be granted access to a media server according to one embodiment of the invention;

FIG. 5 is a perspective view of an electronic device that can be used in the implementation of the present invention; and

FIG. 6 is a schematic representation of the circuitry of the mobile telephone of FIG. 5.

### DETAILED DESCRIPTION OF THE PREFERRED EMBODIMENTS

The present invention provides a CDS security service which, in a user friendly manner, specifies which users of a media server or other UPnP device own which content, as well as permitting the owners to control who is permitted to read the content. A CDS account manager is used for defining user accounts and associated rights, such as validity periods and default rights. The CDS account manager is used by the security console which owns the media server. A CDS content manager is used for manipulating the rights to objects. The CDS content manager is used by a registered security aware control point (i.e., a control point associated with a user account) and can be used to change read and write access lists on the object.

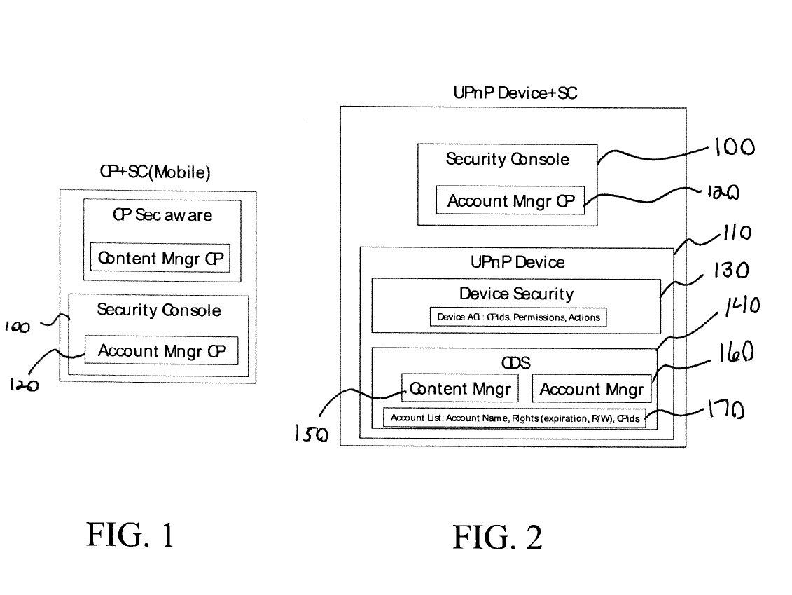

FIG. 1 is a depiction of a security console 100 embedded in a UPnP device in the form of a media server 110. The security console 110 includes an account manager control point 120. The media server 110 includes a device security portion 130 and a CDS portion 140. FIG. 2 is a depiction of a security console 100 that is external to the media server 110 and is located in a device such as a mobile telephone.

The CDS portion 140 of the media server 110 includes two new extensions, as well as an account list 170. The first new extension is a content manager 150, while the second new extension is an account manager 160. The account manager 160 is used for adding and removing accounts and is controlled by the security console. Because no state information is maintained at the security console 100, it does not matter whether the security console 100 is inside or outside of the media server 110. The account manager 160 can also be used by the security console 100 to categorize new control points to existing accounts. This is possible because the security console 100 can query the account manager 160 using its account manager control point 120 and obtain the list of existing accounts (i.e., the account list 170).

The content manager 150 is used to manipulate the CDS objects (i.e. elements and attributes used to restrict the access to the object such as “restricted”, “writeStatus” or new proposed elements for including account and permission information associated with the object) and assign permissions to objects stored on the media server 110. A security aware control point can be used to make modifications on the media server content because it hosts a content manager control point. The media server 110 can authenticate a calling control point and restrict it to modifying access rights only on the objects it itself owns on the media server 110.

The present invention involves extensions to the CDS or CDS portion 140 to allow it to recognize that a control point which is accessing it represents a particular user. This user is represented by an account on the media server 110. The present invention makes it possible for a media server 110 to securely determine that a particular control point represents a particular user. This can occur because of the manner in which new control points are granted access to the media server 110.

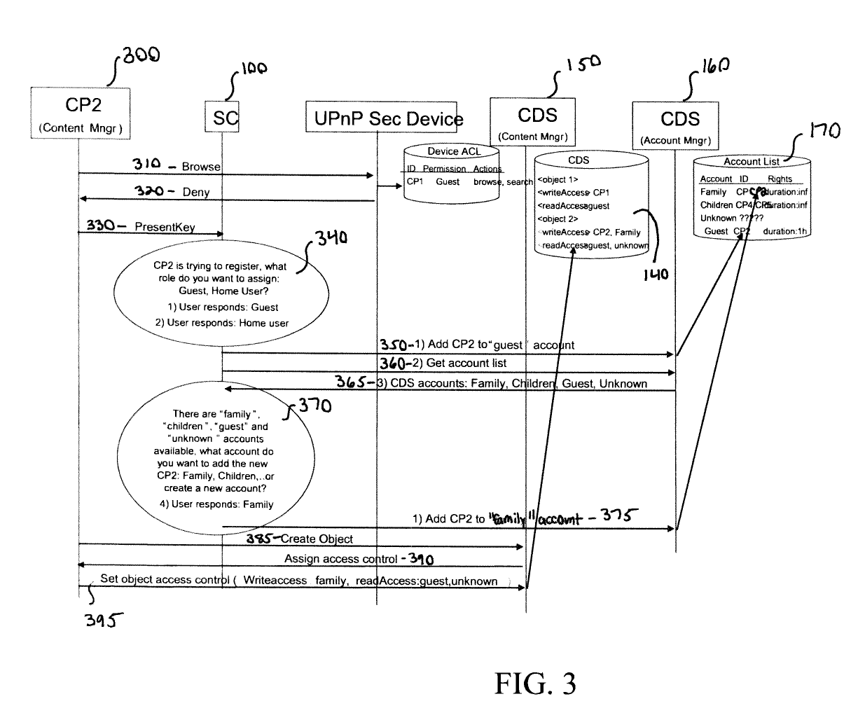

FIG. 3 is a diagram illustrating the sequence of actions which need to take place when a new control point 300 used by a user “Alice” is granted access to the media server 110. At the beginning of the sequence, the new control point 300 becomes connected to the same network as the media server 110. It should be noted that, although the term “media server” is used herein, the present invention is applicable to other UPnP devices as well. The new control point 300 can become connected to this network by, for example, joining the same ad hoc WLAN connection with another user's mobile telephone, where the media server 110 was running. At step 310, the new control point sees that there is a media server 110 running within the network (for example, after receiving a UPnP service advertisement from the media server 110) and attempts to execute a “browse” action on the media server 110. Because the media server 110 is a secure UPnP device, it only grants access to those devices it recognizes. Because the new control point 300 is not recognized, at step 320 the action is denied.

At this point in time, the new control point 300 observes that the media server 110 is security aware. Therefore, the new control point 300 needs to find the security console which owns that media sever 110 in order to obtain access rights to the media server 110. At some point in time, the new control point 300 receives a UPnP service advertisement from a security console 100, and the new control point assumes this to be the device which owns the media server 110. At step 330, the new control point invokes a “presentkey” action of the security console 100 and passes its own public key to the security console 100, along with a friendly name such as “Alice.” The hash of this public key is used as the unique identifier of that security aware control point.

At step 340, a wizard starts and a dialog is displayed to the user of the security console 100 (i.e., the owner of the media server 110). The dialog informs the owner that the new control point 300 is trying to access the media server 110. The dialog asks the owner if the new control point 300 should be a) rejected (and possibly blacklisted); b) allowed as a guest; or c) allowed as a normal user of the media server 110. The user of the security console 100 can then decide, based upon, for example, the public key hash of the control point 100, the friendly name (Alice), or some other identification, the amount of access that should be granted to the control point 100.

If the new control point 300 is not granted access, and if a decision was made to blacklist the user of the new control point 300 (Alice), that user will not be able to even attempt to access the media server 110 after this point. If the owner of the media server 100 indicates that the new control point 300 should be allowed as a guest, then at step 350, an interaction happens between the security console 100 and the CDS's account manager 160. The security console 100 informs the account manager 160 that the new control point 300 (whose ID is the public key hash for the new control point 300) should be added as an allowed control point for the guest account on the media server 110.

If the owner of the media center 110 determines that the new control point 300 is to be allowed as a normal user of the media server 110, then at step 360, the security console 100 sends a request to the account manager 160 and asks for the list of known accounts (the account list 170) on the media server 110. This is an action supported by the account manager 160. The list of CDS accounts is provided to the security console 100 at step 365. The account list 170 is displayed to the user of the security console 100, and the user is asked if the new control point 300 should be added to one of the existing accounts or if a new private account be made for the new control point 300. An example text, shown at 370, asks if the new control point 300 should be added to the “Family” account or if a new account should be created, for example a “friends” account (for friends of the owner of the media server 110) or an “Alice” account that is only for control points controlled by Alice. If the user of the security console 100 decides to treat the new control point 300 as a family member which would not require a separate storage area on the media server 100, the user would choose to add the new control point 300 to the family account. This is represented at step 375. This would be followed by an interaction between the security console 100 and the account manager 160. This interaction subsequently results in the ID of the new control point 300 being added to the list of control point IDs which are recognized as representing the family account.

In another scenario, the user could select that a new account be created for the new control point 300. In this case, the security console 100 would then request that the account manager 160 create the account and update the account list 170 with the new account name and the single control point ID associated with that account.

In cases where the new control point 300 is granted access as a guest or is allowed as a normal user, the new control point 300, once granted access, can create objects on the media server 100. This is represented at step 385. The objects created are marked with metadata which indicate that they are owned by the account of the new control point 300 of Alice. For example, if “Alice” was added to the family account, the metadata will identify the objects as “Family.” One embodiment of the present invention extends the CDS with new metadata to specify, for each stored object, the set of accounts which are allowed to read it and which are allowed to write it. It is also possible for the user of the new control point 300 (Alice) to then set access control rights on all objects owned by the family account in a very fine grained manner, e.g., by saying that guests should be allowed to read them. This is represented at 390. At step 395, the new control point 300 can set object access control parameters for its own objects.

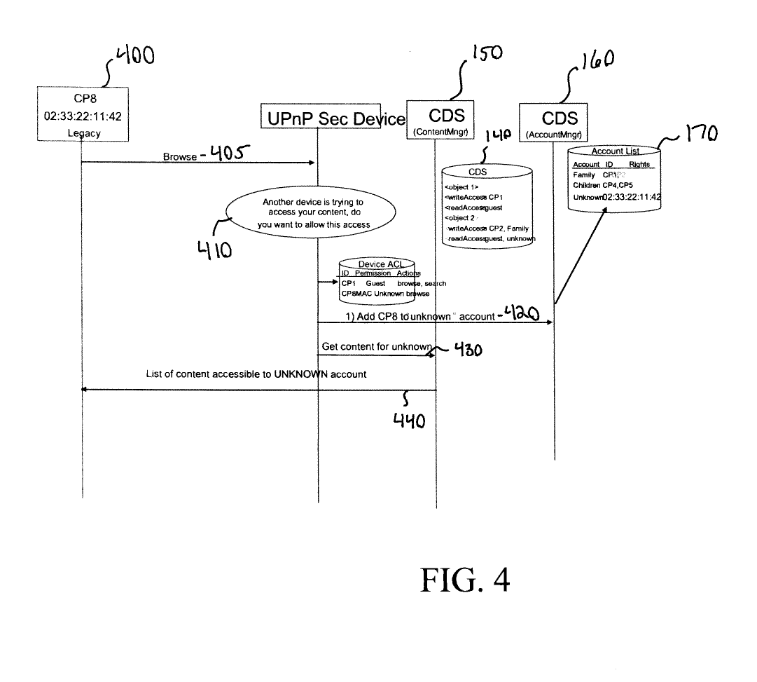

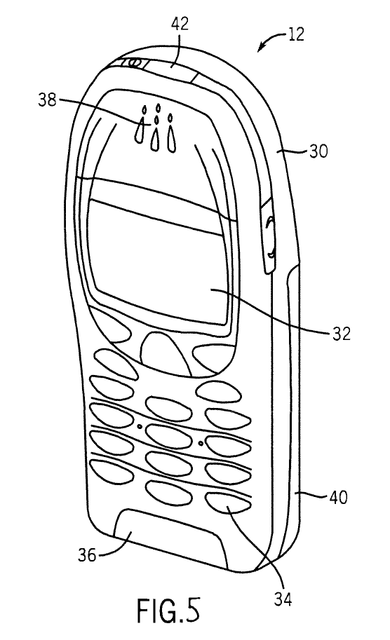

FIG. 4 is a diagram showing how a non-security aware legacy control point 400 can be granted access to a media server 110 according to one embodiment of the invention. At step 405, the legacy control point 400 attempts to browse the contents of the media server 110. The secure media server 110, when receiving the request to browse certain content, notices that there is no authentication in the UPNP action request from the legacy control point 400. The user of the security console 110 is therefore asked by the media server 110 at step 410 whether this action should be allowed and whether access to the public content of the media server 110 should be permitted for the legacy control point 400. It is also possible for the user to configure the media server 110 to always allow items marked as readable for an “unknown” account to be readable by legacy control points 400. The security portion 130 of the security console 100 then indicates that a device belonging to an “unknown” account is now using the media server 110 at step 420 by updating the accounts table with this information. Legacy control points have no secure identifier. Therefore and in order to be able to uniquely identify the new legacy control point 400, either the MAC address+IP address of the device or a cookie mechanism can be used for identification purposes. This would serve the long-lived identifier which would be entered in the list of control point IDs belonging to the “unknown” account. From that point forward, access would be implemented as depicted in FIG. 3. It should be noted that it is also possible for the user of the security console 100 to allow the legacy control point 400 to be entered to the guest account on the media server 110, thereby providing the legacy control point 400 with the ability to access all content which has been marked as readable by the guest account. A list of such content is obtained by the content manager 150 at step 430, and this information is provided to legacy control point 400 at step 440.

In addition to the implementations depicted in FIGS. 3 and 4, a number of variations can also be implemented in accordance with the principles of the present invention. For example, the improved services of the present invention can be implemented in UPnP devices other than a media server 110. Additionally, it is possible that the rights that exist for each control point in the account list 130 be more generic in nature.

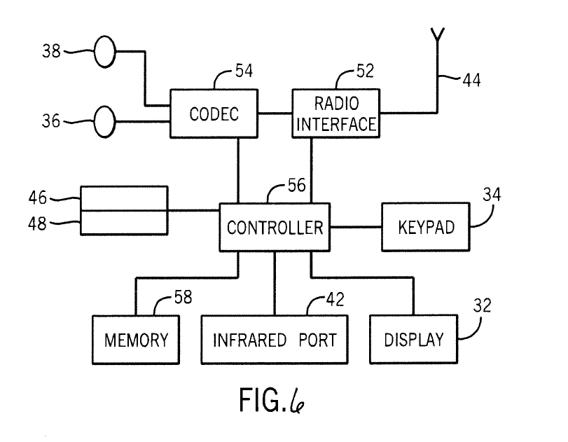

FIGS. 5 and 6 show one representative electronic device 12 within which the present invention may be implemented. It should be understood, however, that the present invention is not intended to be limited to one particular type of mobile telephone or other electronic device. The electronic device 12 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various communication devices may communicate using transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A content directory service system for managing content access on an electronic device having configured to store a plurality of objects thereon, comprising:
a content manager configured to assign permissions to objects stored on the electronic device; and
an account manager configured to manage information regarding accounts of control points that access the electronic device.

2. The content directory service system of claim 1, wherein the electronic device comprises a media server.

3. The content directory service system of claim 1, wherein the account manager is further configured to add and remove individual accounts of users with regard to access of the electronic device.

4. The content directory service system of claim 1, wherein the account manager is further configured to categorize new control points for existing accounts based upon instructions received from a security console.

5. The content directory service system of claim 4, wherein the security console is embedded with the content directory service system in the same device.

6. The content directory service system of claim 4, wherein the security console is included in a device separate from the content delivery service system.

7. The content directory service system of claim 1, wherein the account manager is further configured to provide a list of existing accounts to a security console in response to a query from the security console.

8. The content directory service system of claim 1, further comprising:
an extension contained within content directory service metadata for including at least one of permissions, access rights, user accounts and information associated with each content object; and
a metadata structure for implementing actions involving user information and associated permissions.

9. The content directory service system of claim 8, further comprising additional metadata configured to store access rights for each of the plurality of objects.

10. The content directory service system of claim 9, wherein the additional metadata includes metadata for including at least one of permissions, profiles, accounts and control point information for use in access control.

11. The content directory service system of claim 1, wherein the system is configured to store account information selected from the group consisting of user information, control point identifiers, associated permissions, associated rights, expiration time, authorized actions and combinations thereof.

12. A method of granting a control point certain access to an electronic device containing content objects, comprising:
receiving an identification of the control point;
querying an owner of the electronic device as to the amount of access that should be granted to the control point; and
depending upon a response by the owner to the query, granting the control point selective access to the electronic device.

13. The method of claim 12, wherein the granting of selective access comprises granting the control point one of:
no access rights to the electronic device,
access rights as a guest to the electronic device, and
access rights as a normal user to the electronic device.

14. The method of claim 13, wherein if the control point is granted no access rights, then the control point is permitted to attempt to access the electronic device in the future.

15. The method of claim 13, wherein the granting of access rights as a guest comprises informing a content delivery service account manager that the control point should be added as an allowed control point using a guest account on the electronic device.

16. The method of claim 15, wherein, if access rights are granted to the control point as a guest, the control point is permitted to selectively read and write to objects on the electronic device that are designated as being readable and writable by control points on the guest account.

17. The method of claim 15, wherein, if access rights are granted to the control point as a guest, the control point is permitted to create objects on the electronic device, and wherein the created objects are marked with the identification of the control point.

18. The method of claim 13, wherein the granting of access rights as a normal user comprises:
obtaining a list of known accounts on the electronic device from a content delivery service account manager;
querying the owner of the electronic device as to whether the control point should be added to an existing account or whether a new account should be created;
if the owner responds with an indication that the control point should be added to a particular existing account, having a content delivery service account manager add the identification of the control point to the particular existing account; and
if the owner responds with an indication that the control point should be added to a new account, having the content delivery service account manager create a new account including the identification of the control point and add the new account to the list of known accounts.

19. The method of claim 18, wherein the identification comprises the public key hash of the control point.

20. The method of claim 18, wherein, if the identification of the control point is added to a particular existing account, the control point is permitted to set access control rights on all objects on the electric device that are owned by the particular existing account.

21. The method of claim 13, wherein the granting of selective access comprises, if the control point comprises a non-security aware control point, and if the owner desires to grant limited access rights to the non-security aware control point, permitting the non-security aware control point to access public objects on the electronic device.

22. The method of claim 21, further comprising having a content delivery service account manager update a list of known accounts with the identification of the non-security aware control point.

23. The method of claim 22, wherein the identification comprises a MAC address+IP address of the non-security aware control point.

24. A computer program produced, encoded on a computer-readable medium, for granting a control point certain access to an electronic device containing content objects, comprising:
computer code for receiving an identification of the control point;
computer code for querying an owner of the electronic device as to the amount of access that should be granted to the control point; and
computer code for, depending upon a response by the owner to the query, granting the control point selective access to the electronic device.

25. The computer program product of claim 24, wherein the granting of selective access comprises granting the control point one of:
no access rights to the electronic device,
access rights as a guest to the electronic device, and
access rights as a normal user to the electronic device.

26. The computer program product of claim 25, wherein the granting of access rights as a guest comprises informing a content delivery service account manager that the control point should be added as an allowed control point using a guest account on the electronic device.

27. The computer program product of claim 26, wherein, if access rights are granted to the control point as a guest, the control point is permitted to selectively read and write to objects on the electronic device that are designated as being readable and writable by control points on the guest account.

28. The computer program product of claim 26, wherein, if access rights are granted to the control point as a guest, the control point is permitted to create objects on the electronic device, and wherein the created objects are marked with the identification of the control point.

29. The computer program product of claim 25, wherein computer code for granting of access rights as a normal user comprises:
computer code for obtaining a list of known accounts on the electronic device from a content delivery service account manager;
computer code for querying the owner of the electronic device as to whether the control point should be added to an existing account or whether a new account should be created;
computer code for, if the owner responds with an indication that the control point should be added to a particular existing account, having a content delivery service account manager add the identification of the control point to the particular existing account; and
computer code for, if the owner responds with an indication that the control point should be added to a new account, having the content delivery service account manager create a new account including the identification of the control point and add the new account to the list of known accounts.

30. The computer program product of claim 29, wherein, if the identification of the control point is added to a particular existing account, the control point is permitted to set access control rights on all objects on the electric device that are owned by the particular existing account.

31. The computer program product of claim 25, wherein the granting of selective access comprises, if the control point comprises a non-security aware control point, and if the owner desires to grant limited access rights to the non-security aware control point, permitting the non-security aware control point to access public objects on the electronic device.

32. An electronic device, comprising:
a processor; and
a memory unit communicatively connected to the processor and including a computer program product, encoded on a computer-readable medium, for granting a control point certain access to an electronic device containing content objects, comprising:
computer code for receiving an identification of the control point,
computer code for querying an owner of the electronic device as to the amount of access that should be granted to the control point, and
computer code for, depending upon a response by the owner to the query, granting the control point selective access to the electronic device.

33. The electronic device of claim 32, wherein the granting of selective access comprises granting the control point one of:
no access rights to the electronic device,
access rights as a guest to the electronic device, and
access rights as a normal user to the electronic device.

34. The electronic device of claim 33, wherein the granting of access rights as a guest comprises informing a content delivery service account manager that the control point should be added as an allowed control point using a guest account on the electronic device.

35. The electronic device of claim 34, wherein, if access rights are granted to the control point as a guest, the control point is permitted to selectively read and write to objects on the electronic device that are designated as being readable and writable by control points on the guest account.

36. The electronic device of claim 34, wherein, if access rights are granted to the control point as a guest, the control point is permitted to create objects on the electronic device, and wherein the created objects are marked with the identification of the control point.

37. The electronic device of claim 33, wherein computer code for granting of access rights as a normal user comprises:
computer code for obtaining a list of known accounts on the electronic device from a content delivery service account manager;
computer code for querying the owner of the electronic device as to whether the control point should be added to an existing account or whether a new account should be created;
computer code for, if the owner responds with an indication that the control point should be added to a particular existing account, having a content delivery service account manager add the identification of the control point to the 11 particular existing account; and
computer code for, if the owner responds with an indication that the control point should be added to a new account, having the content delivery service account manager create a new account including the identification of the control point and add the new account to the list of known accounts.

38. The electronic device of claim 37, wherein, if the identification of the control point is added to a particular existing account, the control point is permitted to set access control rights on all objects on the electric device that are owned by the particular existing account.

39. The electronic device of claim 32, wherein the granting of selective access comprises, if the control point comprises a non-security aware control point, and if the owner desires to grant limited access rights to the non-security aware control point, permitting the non-security aware control point to access public objects on the electronic device.
